(19) United States
(12) Patent Application Publication
(10) Pub. No.: US 2020/0031030 A1
(43) Pub. Date: Jan. 30, 2020

(54) INTERNALLY HOLLOW BODY, MOLD AND METHOD THEREOF

(71) Applicants: Fabrizio POLI, Bovezzo,Brescia (IT); Umberto NENNA, Calvagese della Riviera, Brescia (IT)

(72) Inventors: Fabrizio POLI, Bovezzo, BRESCIA (IT); Umberto NENNA, Calvagese della Riviera, BRESCIA (IT)

(21) Appl. No.: 16/484,652

(22) PCT Filed: Feb. 9, 2018
(86) PCT No.: PCT/IB2018/050807

§ 371 Date: Aug. 8, 2019

(30) Foreign Application Priority Data
Feb. 10, 2017 (IT) 102017000015088

(51) Int. Cl. B29C 45/00; B29C 45/16; B65D 6/00

(52) U.S. Cl. CPC B29C 45/0062; B29L 2031/7172; B65D 11/10; B29C 45/162

(57) ABSTRACT

A plastic, internally hollow body has a cavity for containing liquid, solid or gaseous material and comprises a shaped main body and a closure body joined together by a joining element, overmolded to the main body and to the closure body. A method for producing the internally hollow body provides for joining the main body and the closure body in the same step wherein a second closure body and/or of a second main body to be used in a subsequent union step are molded to obtain a second internally hollow body. The internally hollow body is molded by means of a mold comprising punch impressions and die impressions and a movable shaped element which engages with the punch or with the die and which is movable to transfer the first main body from a main die or a punch impression to a union impression of a die or punch.

The present invention relates to the production of internally hollow bodies. In particular, the invention relates to a particular type of internally hollow body made of plastic, such as for example a container, the manufacturing method thereof and the related mold adapted to be used during the manufacturing method.

Plastic hollow containers made by means of rotational molding or blow molding techniques, designed to contain a plurality of liquid, solid or gaseous substances belonging to many sectors of industry (food, chemical, pharmaceutical, etc.) are known in the art. For example, included in this type of containers are those designed to contain substances that must not escape uncontrollably and which therefore must be provided with closure systems (screw caps, pressure covers, valves, etc.)

Internally hollow bodies, such as for example the aforementioned containers, and the respective known production techniques present some disadvantages.

The internally hollow bodies of the prior art produced using traditional molding techniques (rotational molding or blow molding), such as bottles, barrels, jerrycans, flasks, bins, tanks, small cisterns have the disadvantage of being difficult to make in square shapes, for example box-shaped or approximable to those of a parallelepiped with slightly rounded edges. In addition, they generally have a worse exterior finish than the aesthetic finish of products manufactured using the injection molding technique.

Moreover, blow molding does not allow the production of details with constant thickness and, consequently, products made with such technology have areas that require a greater amount of plastic material for producing the container, with a consequent greater demand for resources (financial and material). Furthermore, blow-molding technology and, in particular, rotational molding technology are less productive than other technologies, such as injection molding.

Recently, an internally hollow body made of plastic and a related production technique by injection molding were devised, both described in the patent application with publication number WO2016092407A1 in the name of the same applicants as the present patent application. The hollow body described in WO2016092407A1 is made by the union of two half-shells and the subsequent overmolding by injection of a joining element at the union region of the two half-shells. However, the hollow body and the method of production described in this patent application have some disadvantages. Internally hollow bodies may suffer accidental breakage if subjected to certain load and/or fall tests. In particular, in the event of a fall, it may happen that, as a result of the impulsive impact, one of the two half-shells will detach from the other half-shell and/or the joining element, causing a hole to open and the consequent leakage of the contents.

Moreover, the production times of the hollow bodies according to the prior art are relatively long and produce much waste, limiting the efficiency and effectiveness of production.

One of the objects of the present invention is to improve the robustness of hollow bodies made of plastic, made by molding two half-shells (a main body and a closure body) joined together.

A further object of the present invention is to improve the efficiency and effectiveness of production of such internally hollow bodies.

Such aims are achieved by an internally hollow body, by a method for producing an internally hollow body and by a mold, according to the attached independent claims. The claims dependent on these claims describe variant embodiments.

The features and advantages of the present invention will be apparent from the description given below, provided by way of non-limiting example, in accordance with the accompanying figures, wherein:

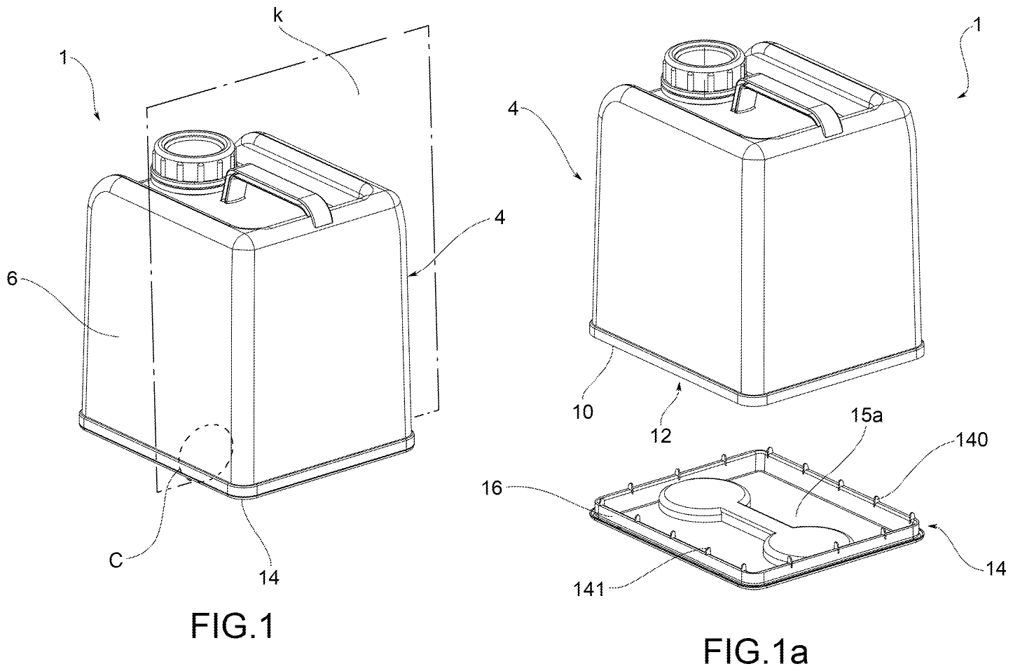

FIG. 1 shows an internally hollow body according to an embodiment of the present invention;

FIG. 1a shows an exploded view of the internally hollow body according to an embodiment of the present invention;

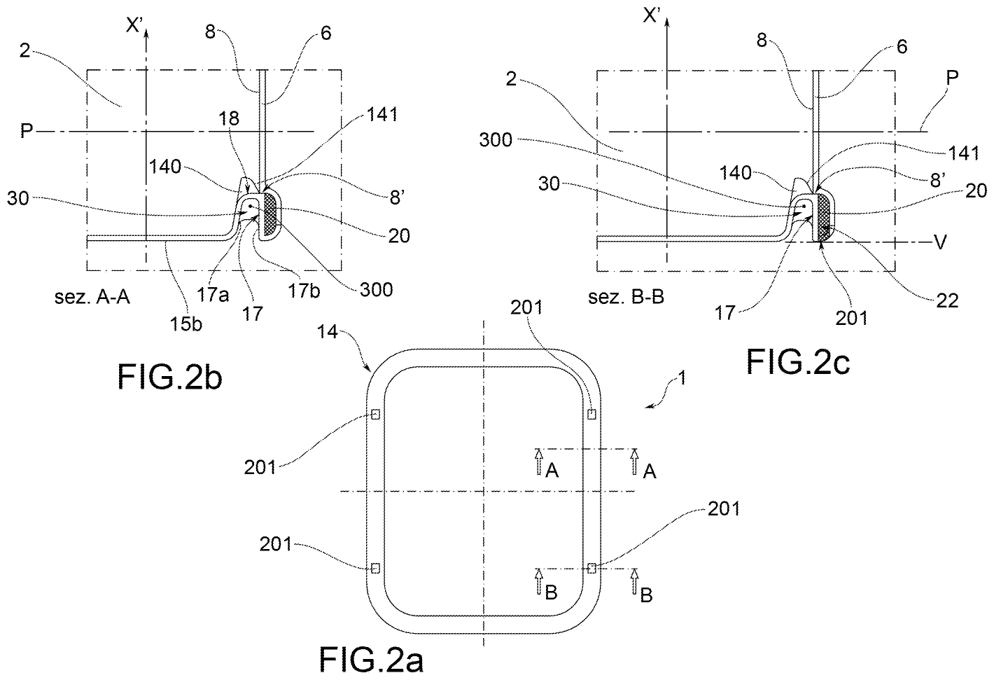

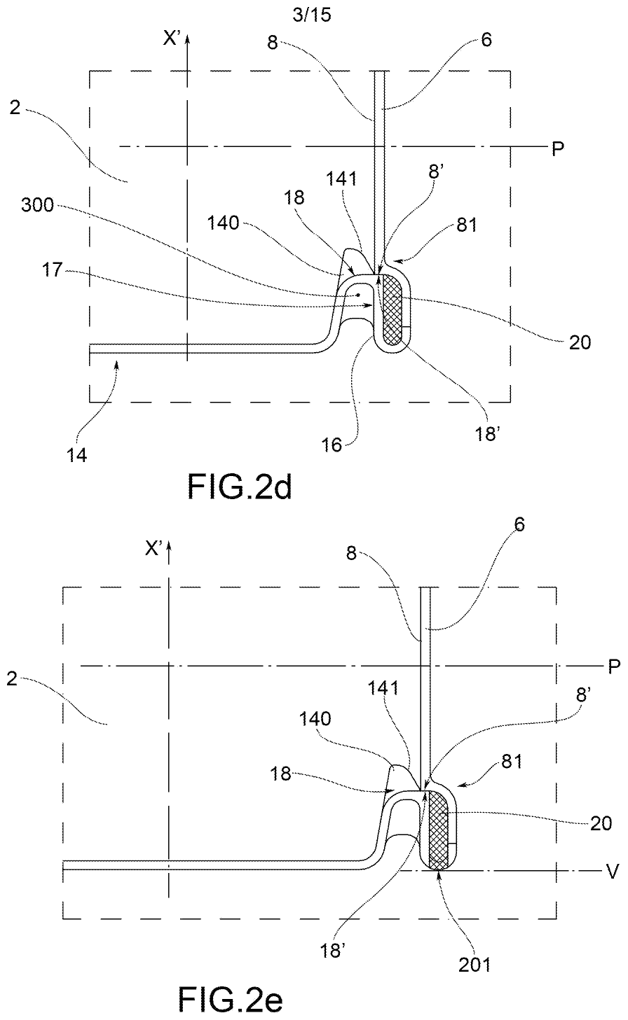

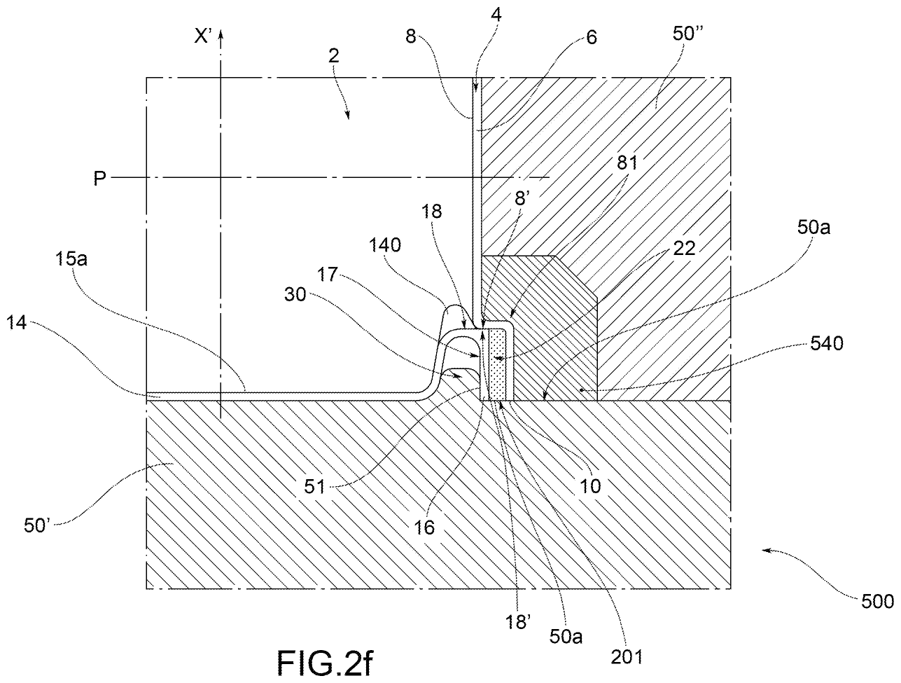

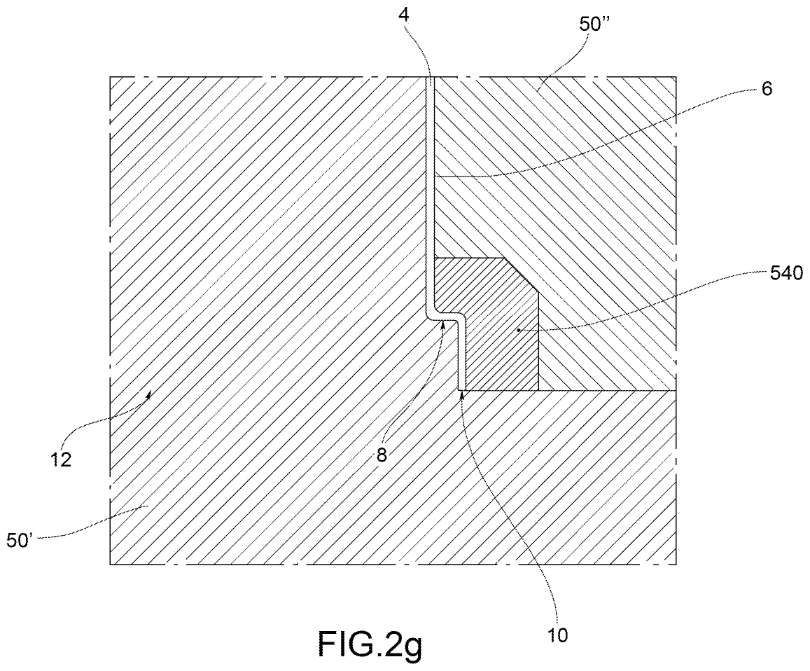

FIG. 2a shows a plan view from below of an internally hollow body according to an embodiment of the present invention;

FIGS. 2b and 2c show a detailed enlargement of an area C in FIG. 1, obtained from a section of the internally hollow body of FIG. 1 along a vertical plane K, respectively, when said plane K is in correspondence with the section plane A-A and B-B in FIG. 2a;

FIGS. 2d and 2e show a detailed enlargement of an area C in FIG. 1, obtained from a section of the internally hollow body of FIG. 1 along a vertical plane K, respectively, when such plane K is in correspondence with the section plane A-A and B-B in FIG. 2a, according to a further variant embodiment of the present invention;

FIG. 2f shows a detailed enlargement of a vertical cross-section of the internally hollow body according to another variant embodiment of the present invention, when the internally hollow body is inserted between the punch and the die during an overmolding step of a joining element between a main body and a closure body of an internally hollow body;

FIG. 2g shows a detailed enlargement of a section of a main body of the internally hollow body according to an embodiment of the present invention, when the main body is inserted between the punch and the die during a molding step of such main body;

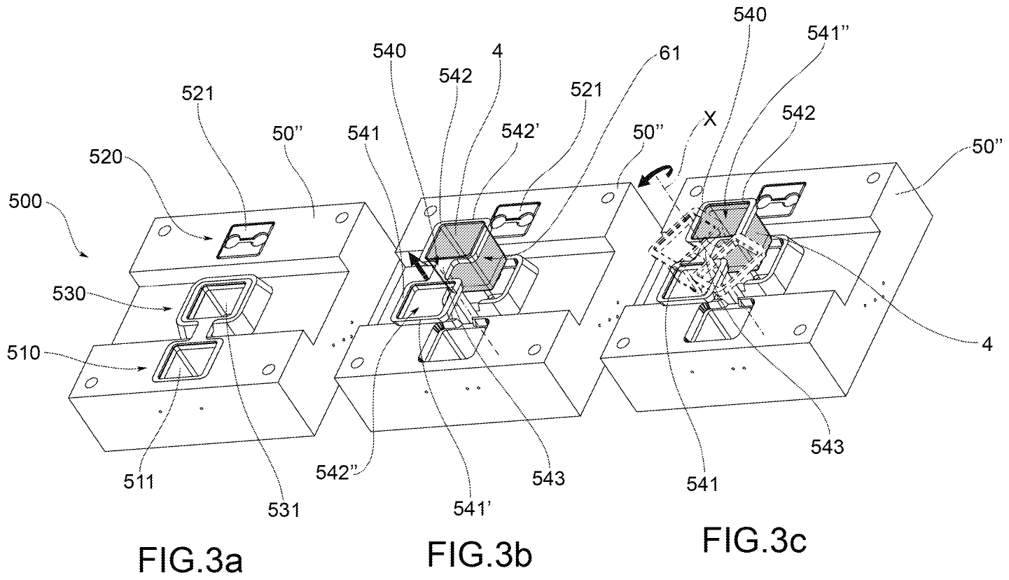

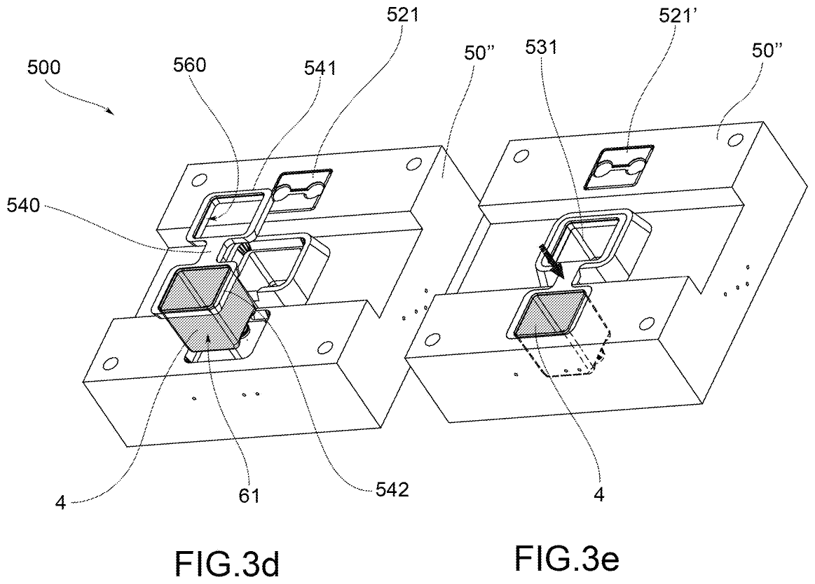

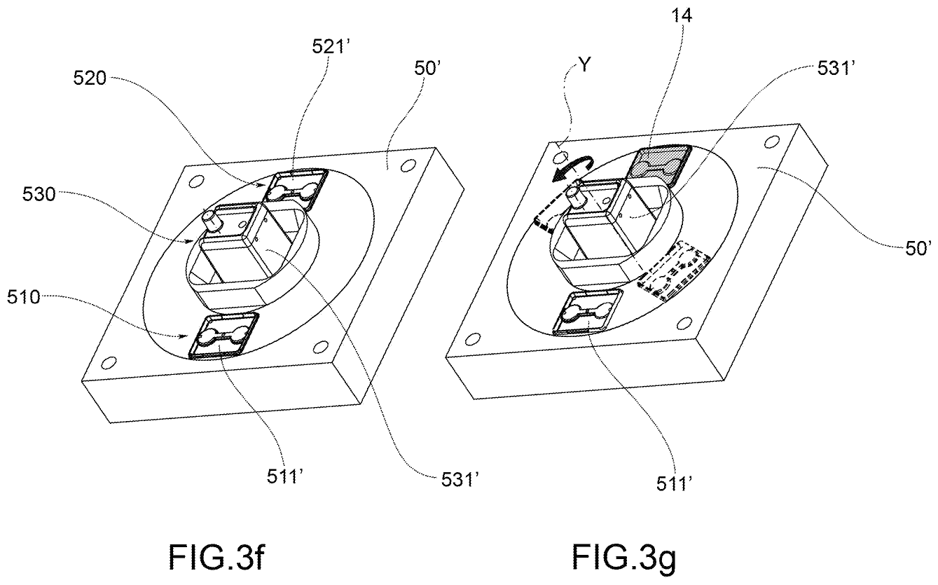

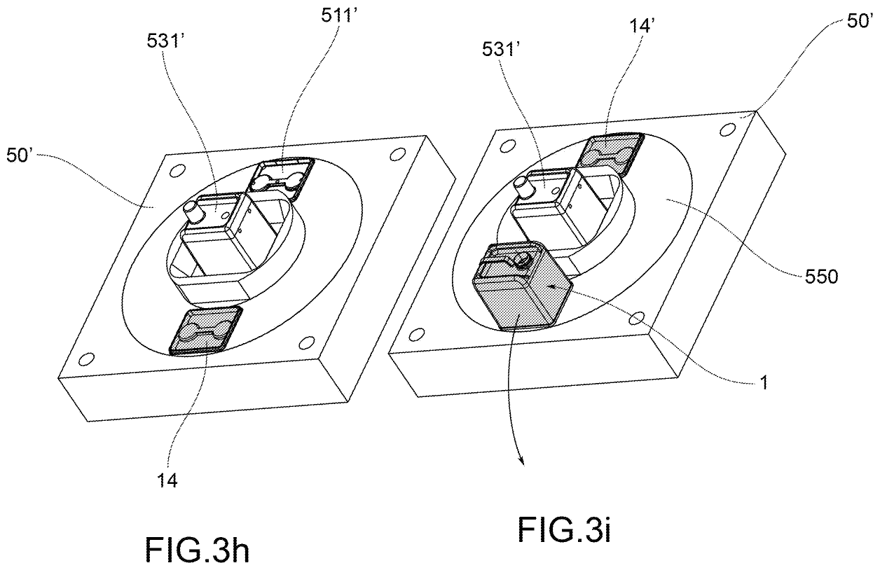

FIGS. 3a to 3i illustrate the steps of the production method of the internally hollow body according to an embodiment of the present invention, by using an embodiment of the mold 500;

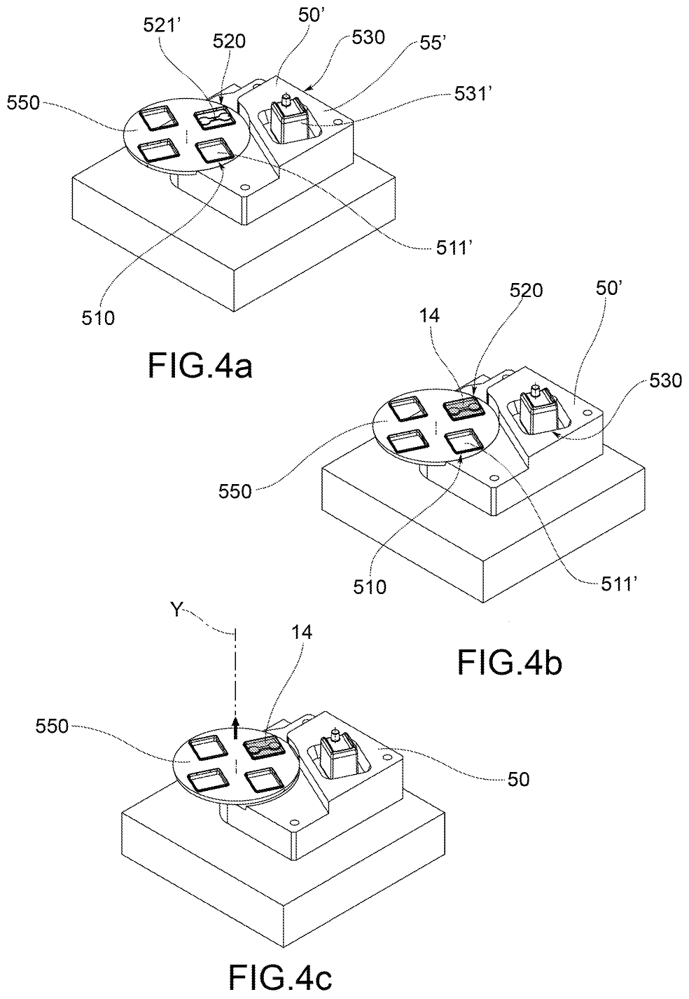

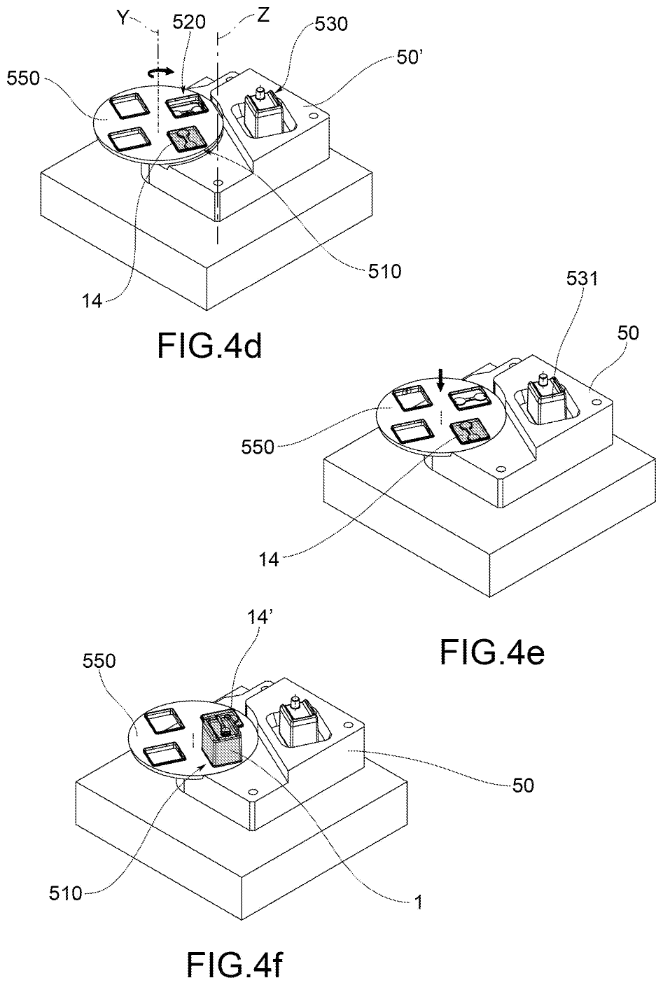

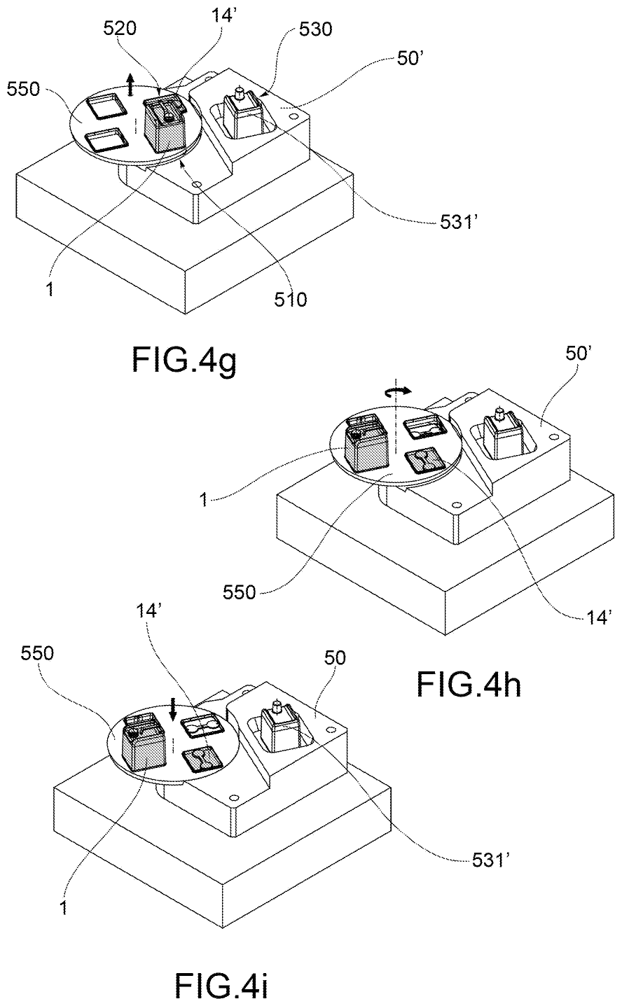

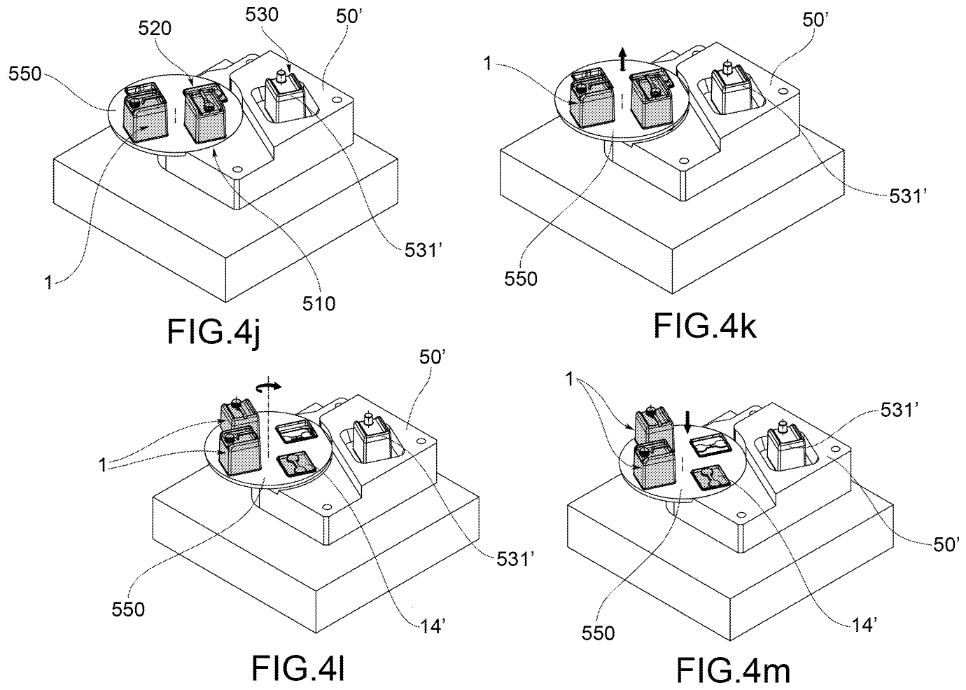

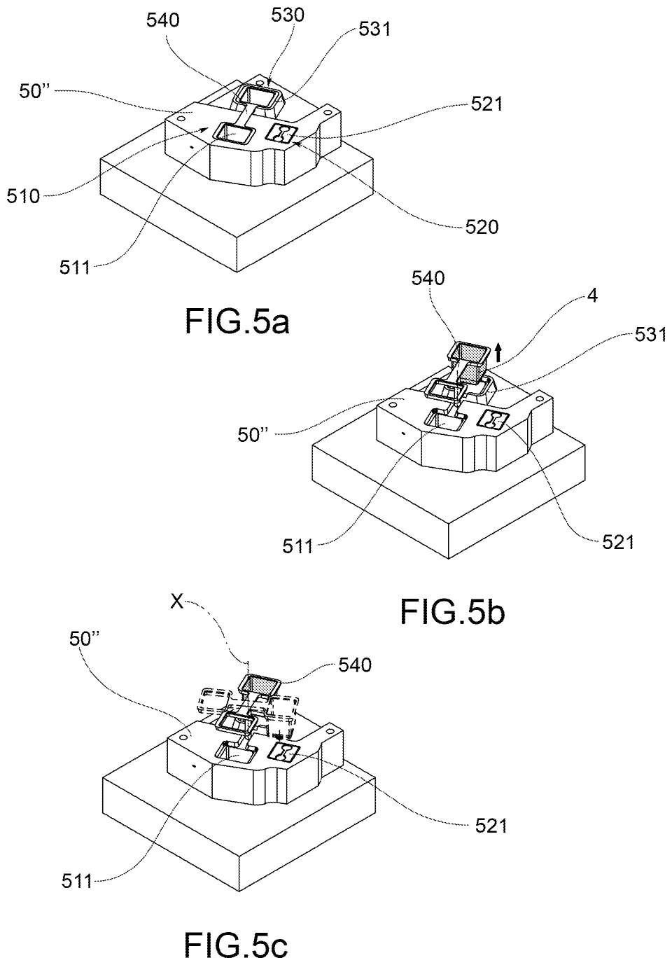

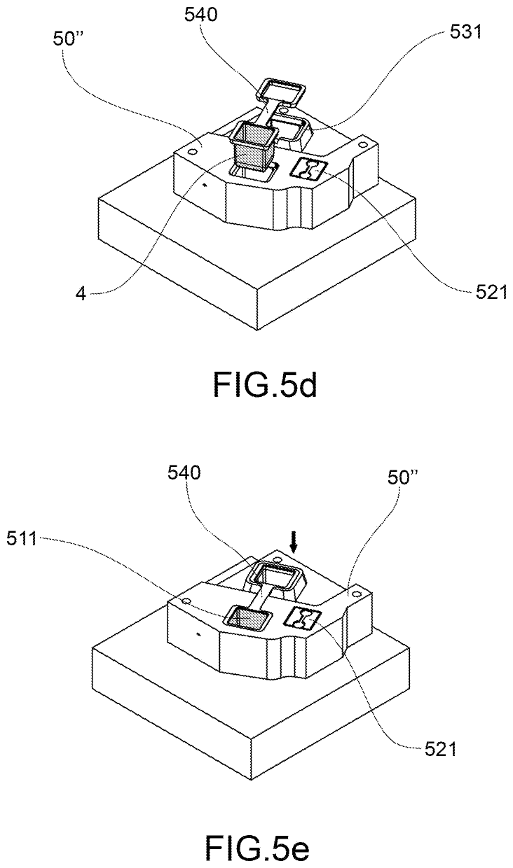

FIGS. 4a to 5e show the steps of the production method of the internally hollow body according to a further embodiment of the present invention and by using another variant embodiment of the mold 500.

In accordance with the accompanying figures, an internally hollow plastic body having an inner cavity 2, preferably adapted to contain liquid, solid or gaseous material is collectively indicated at 1.

The term “internally” means that the cavity 2 of the hollow body is internal to the body, which is to say that, for example, the body has an inner surface that defines, at least partially, such cavity and that is in contact with a liquid, solid or gaseous material that flows, or is contained, at least partially, in the cavity, and an outer surface of the hollow body that instead is in contact with the external environment or, for example, with a different or other element with respect to the one contained, or that flows, in the cavity. This type of internally hollow bodies includes, for example conduits, channels, pipes or container bodies.

The internally hollow body 1 comprises a main body 4 shaped so as to comprise side walls 6, having an inner surface 8 which at least partially defines said cavity 2 and which ends with a shaped edge 10 which delimits an engagement opening 12 to the cavity 2. The internally hollow body 1 further comprises a closure body 14, comprising side closure walls 16 having an inner sealing surface 18. Such inner sealing surface 18 is engaged at least partially with the inner surface 8 of the side walls 6 of the main body 4, and the closure body 14 at least partially closes the cavity 2 at the engagement opening 12.

According to the invention, for example, such closure body 14 is the bottom of a container, as in the embodiment shown in FIG. 1 and FIG. 1a, or the cover, as in the embodiment shown in the document WO2016092407, or one of the two half-shapes that, when joined, form the entire internally hollow body, or simply a portion of the internally hollow body or an ancillary portion (for example a handle of a container, an inlet mouth and the like).

Additionally, according to the invention, the internally hollow body 1 comprises a joining element 20, also made of plastic, having the function of securely joining the main body 4 and the closure body 14.

Preferably, the plastic material with which the joining element 20 is made is adapted to fuse and weld with the plastic material with which the main body 4 or the closure body 14 is made. For example, the joining element is made of the same plastic material as the main body 4 and/or the closure body 14 or with a different plastic but one adapted to fuse with the plastic of the closure body 14 and/or of the main body 4.

The term plastic material or plastic means a polymer, for example a synthetic resin, or an elastomer, or a thermoplastic or thermosetting polymer preferably selected from the group of polyethylenes, polypropylenes, methacrylates, polycarbonates or polyamides.

Between the main body 4 and the closure body 14, there is an overmolding seat 22, and the joining element 20 is overmolded by injection to the main body 4 and the closure body 14, covering such overmolding seat 22.

Preferably, the main body 4 is joined to the closure body 14 at least partially along the shaped edge 10 by means of said joining element 20 or preferably along the entire shaped edge 10.

The overmolding of the joining element 20 on the closure body 14 and on the main body 4 occurs by injection molding, for example through a step of injection molding of a synthetic resin melted in the overmolding seat 22, when the closure body 14 and the main body 4 are mutually engaged and inserted in a mold 500 for overmolding the joining element 20.

Preferably, the closure body 14 is adapted to close completely and sealingly the cavity 2, at the engagement opening 12. In this way, hollow containers are created able to contain, for example, liquid, solid or gaseous substances, such as vials, barrels, jerrycans, flasks, bins, tanks, floats, buoys, lifebuoys, fenders, small cisterns, or bottles, wherein the closure body 14 is preferably the bottom or the cover of such containers. In the case of internally hollow bodies for which, once closed, it is not necessary to access the inner cavity again, such as floats, buoys, lifebuoys or fenders, the closure body 14 and the main body 4 respectively represent each of the two half-shells (preferably equal to each other) to be joined by the joining element to form the buoy, float, lifebuoy or fender.

The closure body 14 has, moreover, a mold engagement cavity 30 in which a mold 500 for injection molding or a part thereof is adapted to counteract the pressure generated in the overmolding seat 22 by injection means during an overmolding step of the joining element 20 and is at least partially couplable by shape-coupling. This mold engagement cavity 30 is preferably formed externally of the cavity 2 of the hollow body 1, i.e. it is at least partially delimited from the outer surface of the closure body opposite the inner surface facing the cavity 2 of the hollow body 1. In other words, the mold engagement cavity 30 is arranged on the opposite side with respect to the inner cavity 2 of the hollow body and is defined at least in part (or totally) by the outer surface adapted to be in contact with the external environment or in any case with a different element than that which is contained or flows into the cavity 2 (i.e. the mold engagement cavity 30 does not face into the cavity 2). For example, such mold engagement cavity 30 is delimited by the outer closure surface 17 of the side closure walls of the closure body, opposite the inner sealing surface 18 towards the mold engagement cavity 30. In this way, one avoids that, during the overmolding step, the injection of the resin forming the joining element 20, causes a disengagement between the inner sealing surface 18 of the closure body 14 and the inner surface 8 of the side walls 6 the main body 4.

Preferably, as shown for example in FIG. 2f, the outer closure surface 17 that defines the mold engagement cavity 30 faces the opposite side with respect to the cavity 2. It follows that the mold 500 engages the mold engagement cavity 30 externally with respect to the cavity 2 of the hollow body 1 obtained at the end of the molding step. In this way, the molding steps are reduced, and it is also possible to produce totally closed hollow bodies 1. In effect, if the mold engagement cavity 30 were formed in the cavity part 2 of the hollow body 1, in the case of totally closed hollow bodies, the mold portion inside the mold cavity 30 and the cavity 2 would not allow the total closure of the hollow body 1. In effect, in this latter case, it would be necessary to leave an access to the cavity 2 free for removing the overmolding mold 500 (or part of it, for example, the die or the punch).

The inner sealing surface 18 of the closure body 14 is engaged at least partially in abutment with the inner surface 8 of the main body 4 along the engagement portion 8′ of such inner surface 8 in such a way as to counteract a mechanical stress between the closure body 14 and the main body 4 along a preferential direction X′ (for example a main vertical direction of extension of the hollow body) and in the direction of insertion of the closure body 14 in the inner cavity 2. In other words, the engagement between the inner sealing surface 18 and the inner surface of the main body 4 allows any compressive stress between the closure body 14 and the main body 4 to be distributed along the side walls 6 of the main body. This advantageously allows any impulsive loads acting between the main body 4 and the closure body 14, for example, the hollow body accidental falling, to be supported. For example, in the case wherein the hollow body 1 is a jerrycan containing liquid, the mechanical stress along the preferential direction X′, due to the jerrycan accidently falling with impact on the closure body 14, would be directly distributed by the closure body 14 to the side walls 6 of the main body 4, ensuring greater impact strength.

Preferably, advantageously, the engagement portion 8′ is an engagement surface inclined with respect to the preferential direction X′, even more preferably perpendicular to the preferential direction X′. For example, the engagement portion 8′ is the rise of a step 81 formed on the side walls 6 of the main body 4.

Preferably, moreover, the inner sealing surface 18 of the closure body 14 comprises an abutment portion 18′, inclined (preferably perpendicular) with respect to the preferential direction X′ and sealingly resting on the engagement portion 8′ of the main body 4. This allows both a sealed joint to be obtained between the closure body 14 and the main body 4 (particularly advantageous in the case of hollow bodies of solid, liquid or gaseous substances) and any mechanical stress to be distributed along an extended contact surface.

Preferably, the joining element 20 is contained along its sides between the side walls 6 of the main body and the side closure walls 16. In this way, the joining element remains hidden from the view of an observer looking at the hollow body along a direction perpendicular to the side walls. Moreover, preferably, having defined a transverse plane P perpendicular to the preferential direction X′ (for example perpendicular to the side walls 6), the joining element 20 is in contact with the external environment only along an outer surface 201, having at least a virtual tangent plane V parallel to said transverse plane P. In other words, for example in the case of a container or a jerrycan, the joining element 20 is preferably in contact with the outside only along a surface thereof facing outwards on the opposite side of the bottom of the container or the jerrycan (for example as shown in FIGS. 2a to 2f).

Preferably, the outer surface 201 of the joining element is in contact with the outside in a discontinuous manner, i.e. only in regions spaced from one another, as shown for example in FIG. 2a. In other words, the joining element is totally contained between the side walls 6 of the main body and the side closure walls 16 of the main body, except at such regions spaced apart from one another in contact with the external environment. In particular, these spaced regions of the outer surface 21 are preferably located at the entry points of the resin during the overmolding step of the joining element 20 inside the mold 500.

In one embodiment (for example shown in FIG. 2f), the joining element 20 is in contact with the external environment only along its outer surface 201, flat and parallel to said transverse plane P.

Furthermore, guide ribs 140 are preferably formed on the closure body 14, adapted to guide the closure body 14 during the step of coupling with the main body 4 towards the inner cavity 2. Preferably, the guide ribs are spaced from one another and protrude from the main body 14 towards the inner cavity 2. Moreover, preferably, the guide ribs 140 comprise an inclined surface 141 adapted to slide along an edge of the side walls 6 of the main body during the coupling step. Such inclined surface 141 is, for example, connected to the abutment portion 18′, so as to facilitate the engagement of the closure body 14 during the insertion step in the main body 4 until it abuts the abutment portion 18′ with the engagement portion 8′ of the main body 4.

The internally hollow body 1 described up to now may be obtained by means of the mold 500 and through a production method according to advantageous variants illustrated in the continuation of the present description.

Mold 500 means a mold for injection molding, for example formed of two or more half-molds, for example a punch 50′ and a die 50″, each bearing an impression designed to engage according to shape-coupling with the main body 4 or with the closure body 14. For example, the main body 4 is inserted in the die 50″ of the overmolding mold 500 according to shape-coupling and the closure body 14 is inserted into the punch 50′ of the mold 500 according to shape-coupling. Preferably, a part of the walls forming the punch and/or a part of the walls forming the die are adapted to counteract the pressure generated on the overmolding seat 22 by the injection means during an overmolding step of the joining element 20.

Preferably, a die wall or only a punch wall 50a (and not both at the same time) is in contact with the synthetic resin during the overmolding step of the joining element, and, in addition to counteracting the pressure during the step of injecting the synthetic resin, such die or punch wall 50a defines an outer closure wall of the overmolding seat of the joining element. In this way, once the overmolded synthetic resin has solidified, at such outer closure wall of the overmolding seat, the outer surface portion 201 of the joining element 20 is formed. In this way, the joining element 20 is contained along its sides between the side walls 6 of the main body and the side closure walls 16, avoiding making the structure of the mold 500 complex.

In one embodiment, the mold engagement cavity 30 comprises an abutment surface 50 adapted to receive in abutment a portion of the mold and side walls forming the outer closure surface 17 on which the mold walls 51 are at least partially engaged to counteract the pressure generated by the injection means during the overmolding step of the joining element 20.

Preferably, the mold engagement cavity 30 has an annular shape with a “U” cross-section.

Preferably, the joining element 20 completely fills the overmolding seat 22, so as to allow stable welding between the main body 4 and the closure body 14.

Preferably, moreover, the overmolding seat 22 (and therefore the joining element 20, once molded), is delimited both on the top and on the side by the inner surface 8 of the side walls 6 of the main body 4 and, on the side facing the inner cavity 2, by the side closure walls 16.

Moreover, preferably, the joining element 20, annularly wraps the hollow body 1, creating a sealing welded ring between the main body 4 and the closure body 14.

In the embodiment wherein the closure body 14 or the main body 4 also acts as the bottom of a container, such main body 4 or the closure body 14 comprises a bottom wall, preferably integral with the side closure walls 16, having an upper bottom surface 15a, which faces the cavity 2 of the container and which constitutes the inner bottom surface of the container. The bottom wall 15 further comprises an outer bottom surface 15b, opposite the upper bottom surface 15a, not communicating with the cavity 2, but facing the outside of the container.

In one variant embodiment, the internally hollow body 1 comprises at least one reinforcing wall 300, arranged transversely between two walls 17a, 17b facing each other and defining the mold engagement cavity 30.

According to the present invention, the method for producing the plastic, internally hollow body provides for joining the main body 4 and the closure body 14 in the same step wherein occurs the molding of a second closure body 14′ and/or of a second main body to be used in a subsequent union step to obtain a second internally hollow body.

Preferably, the production of an internally hollow body 1 according to the present invention further comprises the following steps:

providing a main body 4 shaped in plastic comprising side walls 6, having an inner surface 8 which defines a cavity 2 and which ends with a shaped edge 10 which delimits an engagement opening 12 to the cavity 2;

providing a closure body 14, having closure side walls 16 with an inner sealing surface 18;

engaging the inner sealing surface 18 at least partially with the inner surface 8 of the side walls 6 of the main body 4 so as to close at least partially the cavity 2 at the engagement opening 12 and so that an overmolding seat 22 between the main body 4 and the closure body 14 is formed;

overmolding, by means of injection molding, the joining element 20, so as to fill the overmolding seat 22 with a natural or synthetic resin and welding the main body 4 to the closure body 14 at least partially along the shaped edge 10, and preferably along the whole shaped edge.

Preferably, the main body 4 shaped in plastic and the closure body 14 are made by injection molding.

Furthermore, it is provided that in the mold engagement cavity 30 of the closure body 14 or of the main body 4, the mold 500 is inserted at least partially according to shape-coupling with the mold engagement cavity 30 of the closure body 14 or of the main body 4 in such a way that at least one of the walls of the mold counteracts the pressure generated on the overmolding seat 22 by the injection of natural or synthetic resin by the injection means during the overmolding step of the joining element 20.

Preferably, the overmolding step of the joining element 20, provides that the molten synthetic resin which, once solidified, constitutes the joining element 20, is injected into the molding seat 22 at high temperature, while the main body 4 and the closure body 14 are inserted into the mold 500. In this step, when the molten resin at high temperature comes into contact with the walls of the overmolding seat 22 (for example, the inner sealing surface 18 of the side closure walls 16, the inner surface 8 of the side walls 6, the shaped edge 10), it causes the onset of fusion on the surface, i.e., a new transition of state from solid to molten form, allowing an effective and complete welding of the joining element 20 with the main body 4 and with the closure body 14 due to the fusion of the materials and the subsequent resolidification step.

Referring now to FIGS. 3a to 5e, in accordance with the invention, in a particularly advantageous form, the internally hollow plastic body 1 is made by injection molding in a single mold comprising multiple cavities 510, 520, 530. Each of said multiple cavities 510, 520, 530 is formed by the juxtaposition of respective die impressions 511, 521, 531 and respective punch impressions 511′, 521′, 531′ obtained respectively on the die 50″ and on the punch 50′ of the mold 500. The cavities 510, 520, 530 are then formed when the mold 500 is closed by putting the respective die impressions and the punch impressions together. In each group of FIGS. 3a to 3e and 5a to 5e, a variant embodiment of the die 50″ of the mold 500, coupled with respective punch variants 50′, shown in FIGS. 3f to 3i and 4a to 4m respectively, is illustrated according to a coupling clearly understandable to the person skilled in the art, executable in a cyclic and continuous way. In other words, FIGS. 3a to 3e show the steps of the method on the die 50″ side and FIGS. 3f to 3i show the steps of the method on the punch 50′ side, according to an embodiment. FIGS. 4a to 5e on the other hand show the steps of the production method according to another variant embodiment, wherein FIGS. 4a to 4m show the steps of the punch 50′ side method and FIGS. 5a to 5e show the steps of the die side method 50″.

The production method of the hollow body 1 comprises the steps of:

a) molding a first main body 4 in a main cavity 530 of said multiple cavities 510, 520, 530 and a first closure body 14 in a closure cavity 520 of said multiple cavities 510, 520, 530 (for example by closing the die in FIG. 3a on the punch in FIG. 3f, or the punch in FIG. 4a on the die in FIG. 5a);
b) opening the mold 500;
c) transferring the first main body 4 from a main impression 531, 531′ of such die impressions 511, 521, 531 or punch impressions 511′ 521′, 531′ to a union impression 511, 511′ of such die impressions 511, 521, 531 or such punch impressions 511′, 521′, 531′ by moving a movable shaped element 540 which carries the first main body 4 (for example, as shown in FIGS. 3b to 3e or 5b to 5e);
d) engaging the movable shaped element 540 with the die 50″ or with the punch 50′ of the mold 500 so that such movable shaped element 540 forms a portion of the main impression 531, 531′ of the main cavity 530 when the mold is closed for molding (for example, as illustrated in FIGS. 3e and 5e);
e) in a same step, i.e. keeping the mold closed, molding a second closure body 14′ in the closure cavity 520 and joining the first main body 4 and the first closure body 14 in the union cavity 510 of said multiple cavities 510, 520, 530 (for example, by closing the die in FIG. 3e on the punch in FIG. 3h, or of the punch in FIG. 4e on the die in FIG. 5e or the punch in FIG. 4i on the die in FIG. 5e, or the punch in FIG. 4m on the die in FIG. 5e).

As described above, in step d), therefore, the movable shaped element 540 forms only a portion of the main impression 531, 531′ of the main cavity 530, allowing advantages to be obtained which will be more understood from the continuation of the description.

It is clear that resin is injected into the main cavity 530 to generate the main body 4 and resin is injected into the closure cavity 520 to generate the closure body 14.

In the union cavity 510, the resin is injected into the overmolded seat 22 to overmold the joining element 20 between the main body 4 and the closure body 14.

Moreover, “same step” means that the union between the first closure body 14 and the first main body 4 takes place without opening the mold before the molding of the second closure body 14′ has been completed. In other words, when the mold 500 is closed, the plastic resin is injected both to overmold the joining element between the main body 4 and the closure body 14 in the union cavity 510, and to mold a second closure body 14′ in the closure cavity 520 to be used in a subsequent union (overmolding) step. For example, this is permitted due to an injection device inside the mold (not shown but known to the person skilled in the art) adapted to inject the polymer resin both into the main cavity 530 and into the union cavity 510 and into the closure cavity 520. Furthermore, this is also permitted by the use of a bi-injection press if it is decided to join the two half-shells with a different or other colored material.

Preferably, even more advantageously, in step e) it is also envisaged to mold a second main body to be used in the subsequent union (overmolding) step with the second closure body 14′.

Preferably, moreover, the injection of polymer resin for the molding of the second main body, of the second closure body 14′ and for the overmolding of the joining element 20 between the first main body 4 and the first closure body takes place sequentially or simultaneously in the main cavity 530, the closure cavity 520 and the union cavity 510.

As previously described, in the method according to the present invention, the union of the first main body 4 and the first closure body 14 takes place by injection overmolding of a joining element 20 along the overmolding seat 22.

Preferably, the movement of the movable shaped element 540 comprises the step of rotating the shaped element 540 about an axis of rotation X and translating such movable shaped element 540 along a direction of extraction of the main body 4 from the die 50″ or from the punch 50′.

Preferably, before step c) the movable shaped element 540 is engaged with the die 50″ or with the punch 50′ so as to form at least partially (and therefore not totally), the main impression 531 (as for example illustrated in FIGS. 3a and 5a).

Preferably, moreover, the method comprises the step of:

d1) engaging the movable shaped element 540 with the die 50″ or with the punch 50′ of the mold 500 so that the movable shaped element 540 forms a portion of the union impression 511 of the union cavity 510 when the mold is closed for molding.

In an advantageous variant of the method, step d1) is carried out substantially simultaneously with step d). In other words, the movable shaped element 540 engages both with the union cavity 510 and with the main cavity 530 so as to form a portion of the union impression 511 and a portion of the main impression 531 when the mold is closed for molding. It is therefore clear that the movable shaped element 540 engages both with the union cavity 510 and with the main cavity 530 in such a way as to form only a portion of the union impression 511 and only a portion of the main impression 531, and not the totality of the impression 511 and/or of the main impression 531, when the mold is closed for molding.

As already said and as illustrated in the accompanying FIGS. 3a to 5e, the present invention is also aimed at some advantageous embodiments of a mold 500 for producing the internally hollow body.

Such mold 500 comprises:

a die 50″ comprising a main die impression 531, a die union impression 511 and a die closure impression 521;

a punch 50′ comprising a main punch impression 531′, a union punch impression 511′ and a punch closure impression 521′.

The punch impressions 511′, 521′, 531′ and the die impressions 511, 521, 531 are adapted to come together to form the multiple molding cavities 510, 520, 530, already described above.

As said, the mold 500 further comprises a movable shaped element 540 movable for transferring the first main body 4 from the main impression of the die 531 or of the punch 531′ to the union impression of the die 511 or of the punch 511′. Moreover, such a movable shaped element 540 is adapted to engage with the die 50″ or with the punch 50′ of the mold 500 so as to form at least a portion of the main impression of the die 531 or of the punch 531′.

Preferably, the movable shaped element 540 is adapted to engage with the die 50″ or with the punch 50′ so as to form at least a portion of the union impression of the die 511 or of the punch 511′.

In an advantageous variant embodiment, the movable shaped element 540 comprises a union portion 541 and a main portion 542 joined together by a connecting portion 543. The union portion 541 and the main portion 542 are adapted to engage with the union impression of the die 511 and with the main impression of the die 531 or with the union impression of the punch 511′ and with the main impression of the punch 531′.

As will therefore be more understandable hereinafter, an advantageous embodiment provides that the movable shaped element 540 is adapted to engage with the die 50″ or with the punch 50′ so as to form only a portion of the union impression of the die 511 or the punch 511′.

Preferably, the union portion 541 and the main portion 542 each comprise a frame 541′, 542′ which surrounds a housing 541″, 542″ adapted to receive the main body 4 therein. Such frame 541′, 542″ is adapted to engage with the punch or with the die to form a portion of the union impression and/or the main impression of the punch or the die.

The possibility of moving only a portion of the union impression and/or the main impression of the punch or die allows reduced inertias to be obtained during the movement and therefore higher speeds of movement (for example of rotation), as well as require less power of the movement actuator means.

In a preferred variant embodiment, the frame 541′, 541″ comprises an inner side surface 560, which faces the housing 541″, 542″. Such inner side surface 560 is shaped in such a way as to engage with the outer side surface 61 of the main body 4 (for example the outer surface of the side walls 6). Such outer side surface 61 is the surface of the main body which faces away from the inner cavity 2 of the hollow body 1.

In an advantageous embodiment, the shaped movable element 540 is rotatable about an axis of rotation X parallel to the direction of movement of the die 50″ and of the punch 50′ in the closing/opening of the mold 500. Such movable shaped element 540 is moreover translatable along the extraction direction of the main body 4 from the die or the punch.

In one embodiment of the mold 500, the punch 50′ comprises a rotating base 550, rotatable about a base axis of rotation Y. On such rotating base 550 are supported the punch union impression 511′ and the punch closure impression 521′.

In one embodiment, the rotating base 550 is arranged about the main punch impression 531′. Preferably, the base axis of rotation Y passes through the main impression of the punch 531′. Still more preferably, the rotating base 550 is in the shape of a circular crown arranged around the main impression of the punch 531′. Moreover, preferably, the base axis of rotation Y coincides with the central axis Z of the mold 500.

With more detailed reference to the variant embodiment of the method illustrated in FIGS. 3a to 3i, in order to obtain the internally hollow body 1, it is envisaged to mold first the main body 4 and the closure body 14 (closing the die in FIG. 3a on the punch in FIG. 3f). After having opened the mold, by means of the movable shaped element 540, the main body 4 is extracted from the main impression 531 (FIG. 3b), and the main body (FIG. 3c) is rotated to insert it into the union impression 511 (FIGS. 3d, 3e). On the punch side 50′, the rotating base 550 (FIGS. 3g, 3h) is moved so as to bring the closure body 14 into a position corresponding to the union cavity 510 (FIG. 3h). Subsequently, the mold 500 is closed (the die in FIG. 3e with the punch in FIG. 3h). The main body 4 and the closure body 14 engage with each other and the joining element 20 is overmolded by injection in the union cavity 510 and at the same time a second closure body 14′ is molded into the closure cavity 520 and a second main body is molded in the main cavity 530; then the mold is opened (FIG. 3i) and the finished hollow body 1 is picked up. At this point, the molding resumes again cyclically with the extraction of the second main body from the main impression 531 (FIG. 3b) and with the movement of the rotating base 550 (FIGS. 3g, 3h) so as to bring the second closure body 14′ into the position corresponding to the union cavity 510 (FIG. 3h) and so on.

In another advantageous embodiment (shown for example in FIGS. 4a to 4m), the rotating base 550 is arranged adjacent to the main punch impression 531′.

Preferably, in this latter embodiment, the base axis of rotation Y does not pass through the main punch impression 531′.

Preferably, the base axis of rotation Y is spaced with respect to the central axis of the mold 500. In this case, advantageously, by means of a simple rotation, the finished hollow body 1 is positioned in a position further from the center of the mold, towards the periphery of the mold, guaranteeing an easier and more convenient pick-up of the finished piece.

With more detailed reference to the variant embodiment of the method illustrated in FIGS. 4a to 5e, in order to obtain the internally hollow body 1 it is envisaged to mold first the main body 4 and the closure body 14 (by closing the die in FIG. 5a on the punch in FIG. 4a). After having opened the mold, the main body 4 is extracted from the main impression 531 (FIG. 5b) by means of the movable shaped element 540, and the main body (FIG. 5c) is rotated to insert it into the union impression 511 (FIGS. 5d, 5e). On the punch side 50′, the rotating base 550 (FIGS. 4b to 4e) is moved so as to bring the closure body 14 into a position corresponding to the union cavity 510 (FIG. 4e). Preferably, the rotating base 550 is moved by means of a first translation movement along the base axis of rotation Y adapted to detach the closure body 14 from the closure impression 521′ of the punch. Rotating means of the rotating base then move the base about the base axis of rotation Y to bring the closure body 14 to correspond with the union cavity 510 (FIG. 4d). Subsequently, translation means of the rotating base 550 move the rotating base 550 with a second translation movement in the direction opposite to the first translation movement along the base axis of rotation Y (FIG. 4e).

In this variant embodiment, contrary to the variant embodiment shown in FIGS. 3f to 3i wherein the closure impression 521′ rotates integrally with the rotating base 550, the closure impression 521′ is fixed and integrally supported by a base body 55′ of the punch 50′, separate from the rotating base. In this case, the rotating base 550 acts only as a transport tray for the closure body 14, allowing a reduction of the total mass of the base to be rotated and the relative inertial moments during rotation. Advantageously, this allows the torque that the rotating means must deliver to rotate the rotating base to be reduced, with a consequent reduction of the dimensions of the rotation means, an increase in the speed of variation of the rotation (and of the molding times) and simplification of the mold structure. Subsequently, the mold 500 is closed (the die in FIG. 5e with the punch in FIG. 4e). The main body 4 and the closure body 14 engage with each other and the joining element 20 is overmolded by injection in the union cavity 510 and at the same time a second closure body 14′ is molded in the closure cavity 520 and a second main body in the main cavity 530; then, the mold is opened (FIG. 4f). At this point, the molding resumes again cyclically with the extraction of the second main body from the main impression 531 (FIG. 5b) and with the movement of the rotating base 550 as already described previously (FIGS. 4g to 4i), so as to bring the second closure body 14′ into the position corresponding to the union cavity 510 (FIG. 4) and so on (FIGS. 4j to 4m).

It is moreover clear that the aforementioned steps described and represented in the figures are intended to be carried out within a production method preferably performed continuously over time and, therefore, comprising intermediate steps not described or illustrated as they are understandable to a person skilled in the art.

Innovatively, the internally hollow body 1 according to the present invention, due to the particular configuration of engagement between the closure body and the main body and to the disposition of the joining element, allows any impulsive and compression loads acting on the hollow body to be resisted in a more robust manner and at the same time maintains a pleasant overall aesthetic of the product by not showing the unsightly joining element.

Moreover, the production method of the internally hollow body 1 described in the preceding paragraphs, allows several types of internally hollow bodies (for example containers) to be made mainly for the food, chemical or petrochemical sectors, or for cleaning or pharmaceutical sectors, or for glues or paints or solvents, or for the boating or gardening sectors.

In particular, in an innovative manner, the method according to the present invention allows internally hollow bodies for injection molding to be made in a more efficient manner, due to the union between the main body and the closure body and to the simultaneous molding of a second closure body, usable in the subsequent union cycle for overmolding.

Advantageously, therefore, the method allows one to combine, on the one hand, the advantages of injection molding techniques with respect to blow molding or rotational molding techniques, and on the other it allows one to speed up the production, increasing efficiency. This allows both the range of shapes and finishes of internally hollow bodies that may be achieved to be expanded and the manufacture process to be improved.

Advantageously, moreover, the production method of internally hollow bodies according to the present invention, allows the parallelization of the molding process to be increased, due to the possibility of simultaneously molding several internally hollow bodies and at the same time multiple main bodies and closure bodies, eliminating at least the step of withdrawing the closure body (or of the main body) from the mold and the subsequent insertion into the mold intended for overmolding, “replacing it” with rotating operations of a movable shaped element and a rotating base. This makes it possible to move on to the overmolding phase of the joining element in a quicker and more automated manner and, therefore, with an improved productive efficiency.

Moreover, since the movable element and the rotating base are relatively light devices, they do not require expensive and complicated handling means, which, however, are required in the case of rotating entire half-molds of greater weight and subject to greater inertias. In effect, due to the reduced inertias, the movable element and the rotating base may be moved more quickly, reducing the total molding times.

It is clear that one skilled in the art, in order to meet specific needs, may make changes to the hollow body, to the mold or to the production method described above, all contained within the scope of protection defined by the following claims.

1. Internally hollow plastic body, having a cavity, adapted to contain liquid, solid or gaseous material, comprising:
a main body shaped so as to comprise side walls, having an inner surface that at least partially defines said cavity and comprising an engagement portion, said inner surface delimiting an engagement opening with the cavity;
a closure body comprising side closure walls having an inner sealing surface, said closure body closing at least partially the cavity at the engagement opening;
a joining element made of plastic, which joins the main body to the closure body, said joining element covering an overmolding seat between the main body and the closure body;
wherein the closure body has a mold engagement cavity in which a mold for injection molding can be at least partially coupled by shape-coupling, adapted to counteract the pressure generated in the overmolding seat by injection means during an overmolding step of the joining element,
and wherein the inner sealing surface of the closure body is engaged at least partially in abutment with the inner surface of the main body along the engagement portion in such a way as to counteract a mechanical stress between the closure body and the main body along a preferential direction and in the direction of insertion of the closure body in the inner cavity.

2. Internally hollow body according to claim 1, wherein the engagement portion is an engagement surface inclined with respect to the preferential direction.

3. Internally hollow body according to claim 1, wherein the engagement portion is the rise of a step formed on the side walls of the main body.

4. Internally hollow body according to claim 2, wherein the inner sealing surface of the closure body comprises an abutment portion, inclined with respect to the preferential direction and sealingly resting on the engagement portion of the main body.

5. Internally hollow body according to claim 1, wherein the joining element contained along its sides between the side walls of the main body and the side closure walls and wherein, having defined a transverse plane perpendicular to the preferential direction, said joining element is in contact with the external environment only along an outer joining element surface thereof, said outer surface having at least one virtual tangent plane parallel to said transverse plane.

6. Method for the production of an internally hollow plastic body according to claim 1, by injection molding in a mold comprising multiple cavities, each of said multiple cavities being formed by approaching respective die impressions and respective punch impressions formed on the die and on the punch, respectively, of the mold, the method comprising the steps of:
a) molding a first main body in a main cavity of said multiple cavities and a first closure body in a closure cavity of said multiple cavities;
b) opening the mold;
c) transferring the first main body from a main impression of said die or punch impressions to a union impression of said die or punch impressions by moving a movable shaped element which carries the first main body;
d) engaging the movable shaped element with the die or with the punch of the mold so that said movable shaped element forms a portion of the main impression of the main cavity when the mold is closed for molding;
e) molding a second closure body in the closure cavity and, while keeping the mold closed, in the union cavity of said multiple cavities overmolding by injection a joining element between the main body and the closure body along an overmolding seat.

7. Method according to claim 6, wherein the movement of the movable shaped element comprises the step of rotating the movable shaped element about an axis of rotation and translating the movable shaped element along a direction of extraction of the main body from the die or from the punch.

8. Method according to claim 6, wherein before step c), the movable shaped element is engaged with the die or with the punch in such a way as to at least partially form the main impression.

9. Method according to claim 8, wherein the movable shaped element is engaged with the die or with the punch in such a way as to not totally form the main impression.

10. Method according to claim 6, further comprising the step of:
d1) engaging the shaped element with the die or with the punch of the mold so that said movable shaped element forms a portion of the union impression of the union cavity when the mold is closed for molding.

11. Method according to claim 10, wherein step d1) is carried out substantially simultaneously with step d).

12. Method according to claim 6, wherein in step e) a second main body is molded in the main cavity.

13. Mold for the production of a plastic hollow body having an inner cavity, by injection molding of a main body, a closure body and a joining element between the main body and the closure body, comprising:
a die comprising a main die impression, a die union impression and a die closure impression;
a punch comprising a main punch impression, a punch union impression and a punch closure impression;
said punch impressions and die impressions being adapted to be placed side by side to form multiple molding cavities;
said mold comprising a movable shaped element movable for transferring the first main body from the main die or punch impression to the die union or punch union impression, said movable shaped element being adapted to engage with the die or with the punch of the mold so as to form at least a portion of the main die impression or punch impression.

14. Mold according to claim 13, wherein the movable shaped element is adapted to engage with the die or with the punch of the mold so as to form at least a portion of the die union impression or punch union impression.

15. Mold according to claim 13, wherein the movable shaped element comprises a union portion and a main portion joined together by a connecting portion, wherein the union portion and the main portion are adapted to engage both with the die union impression and the main die impression or with both the punch union impression and the main punch impression.

16. Mold according to claim 15, wherein the union portion and the main portion each comprise a frame which surrounds a housing adapted to accommodate the main body at its interior, said frame being adapted to engage with the punch or with the die to form a portion of the union impression and/or of the main impression of punch or die.

17. Mold according to claim 16, wherein the frame comprises an inner side surface, which faces towards the housing and shaped so as to engage with an outer side surface of the main body, said outer side surface being facing the opposite side with respect to the inner cavity of the hollow body.

18. Mold according to claim 13, wherein the movable shaped element is rotatable about an axis of rotation parallel to the movement direction of the die and punch during the closing/opening of the mold, said movable shaped element also being movable along an extraction direction of the main body from the die or the punch.

19. Mold according to claim 13, wherein the punch comprises a rotating base, rotatable about a basic axis of rotation, on said rotating base being supported or obtained the punch union impression and the punch closure impression.

20. Mold according to claim 19, wherein the rotating base is arranged around the main punch impression.

21. Mold according to claim 20, wherein the rotating base is arranged next to the main punch impression, the basic axis of rotation being spaced with respect to a central axis of the mold.
